(19) United States
(12) Patent Application Publication
(10) Pub. No.: US 2011/0279344 A1
(43) Pub. Date: Nov. 17, 2011

(54) RADIO FREQUENCY PATCH ANTENNAS FOR WIRELESS COMMUNICATIONS

(76) Inventors: ZIMING HE, Irvine, CA (US); PING PENG, Irvine, CA (US); OLEKSANDR GORBACHOV, Irvine, CA (US)

(21) Appl. No.: 13/106,762

(22) Filed: May 12, 2011

Related U.S. Application Data
(60) Provisional application No. 61/334,132, filed on May 12, 2010.
(60) Provisional application No. 61/334,026, filed on May 12, 2010.
(60) Provisional application No. 61/334,128, filed on May 12, 2010.

(51) Int. Cl. H01Q 9/04; H01Q 1/50; H01Q 1/42

(52) U.S. Cl. 343/852; 343/700 MS; 343/872

(57) ABSTRACT

An antenna assembly connectible to a radio frequency (RF) front end integrated circuit is disclosed. The antenna assembly includes a feed port connectible to a feeding line. There is a set of inner patch elements each having substantially identical first dimensions corresponding to a center resonant operating frequency, and also define perpendicular slots of predetermined lengths. The inner patch elements are in a spaced, parallel relationship. A set of outer patch elements each has substantially identical second dimensions. The inner patch elements are in a spaced, parallel and interposed relationship between the set of outer patch elements. A first electrically conductive element of the feed port is connected to a first one of the inner patch elements, and a second electrically conductive element of the feed is connected to a second one of the inner patch elements.

### CROSS-REFERENCE TO RELATED APPLICATIONS

This application relates to and claims the benefit of U.S. Provisional Application No. 61/334,132, filed May 12, 2010 and entitled “CROSS-POLARIZED HIGH GAIN AND WIDEBAND PATCH ANTENNA FOR WLAN MIMO APPLICATIONS,” U.S. Provisional Application No. 61/334,026 filed May 12, 2010 and entitled “11 dBi HIGH GAIN WIDEBAND PATCH ANTENNA ARRAY FOR WLAN APPLICATIONS” and U.S. Provisional Application No. 61/334,128 filed May 12, 2010 and entitled “HIGH GAIN AND BROAD RADIATION PATTERN ANTENNA FOR WLAN APPLICATIONS,” each of which are wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radio frequency (RF) communications and antennas, and more particularly to patch antennas, cross-polarized patch antennas, and patch antenna arrays for use with RF integrated circuits in industrial-scientific-medical (ISM) band wireless networking.

2. Related Art

Wireless communications systems find application in numerous contexts involving information transfer over long and short distances alike, and there exists a wide range of modalities suited to meet the particular needs of each. These systems include cellular telephones and two-way radios for distant voice communications, as well as shorter-range data networks for computer systems employing technologies such as the Wireless Local Area Network (WLAN), Bluetooth, and Zigbee, among many others. Generally, wireless communications involve a radio frequency (RF) carrier signal that is variously modulated to represent data, and the modulation, transmission, receipt, and demodulation of the signal conform to a set of standards for coordination of the same.

One fundamental component of any wireless communications system is the transceiver, i.e., the transmitter circuitry and the receiver circuitry. The transceiver encodes information (whether it be digital or analog) to a baseband signal and modules the baseband signal with an RF carrier signal. Upon receipt, the transceiver down-converts the RF signal, demodulates the baseband signal, and decodes the information represented by the baseband signal. The transceiver itself typically does not generate sufficient power or have sufficient sensitivity for reliable communications. The wireless communication system therefore includes a front end module (FEM) with a power amplifier for boosting the transmitted signal, and a low noise amplifier for increasing reception sensitivity.

Another fundamental component of a wireless communications system is the antenna, which is a device that allow for the transfer of the generated RF signal from the transmitter/front end module to electromagnetic waves that propagate through space. The receiving antenna, in turn, performs the reciprocal process of turning the electromagnetic waves into an electrical signal or voltage at its terminals that is to be processed by the receiver/front end module.

In its most basic form, a wireless communications system utilizes a single input/output channel, but there have been several developments that employ multiple simultaneous inputs and outputs (MIMO, or multiple-input, multiple-output). Significant data throughput and link range increases may be realized without additional bandwidth or transmission power. There are multiple antennas at both the transmitting end and the receiving end. Commonly, patch antennas are utilized for MIMO systems for its higher gain and increased isolation characteristics. That is, two orthogonal field modes can be excited, resulting in improved isolation between the multiple ports of a single patch antenna.

A wireless networking environment is typically comprised of an access point and one or more wireless devices in communication therewith. The access point, in turn, is connected to a wired network, thus enabling access by the wireless devices to the wired network. The access point and the wireless devices have the fundamental transceiver, front end module, and antenna components. Conventional implementations of access points utilize a dipole antenna with a peak gain of about 2 dBi and a relatively narrow half power beamwidth (HPBW) in a vertical plane limited to 20° to 30°. Accordingly, the operating range of such access points is limited and may not provide an ideal extent of network coverage. Some extremities of a network deployment location such as room and building corners and the like may have accessibility gaps.

Optimal performance of a communications system, whether it is the aforementioned WLAN environment, MIMO modalities, or other ISM band applications, is dependent upon the configuration of both the antenna and the front end circuit. It is desirable for the antenna to have a high gain as well as a wide bandwidth. There must also be an adequately low return loss, ideally better than −15 dB, so that satisfactory performance of the transceiver and the front end module are maintained even when the operating point has drifted beyond a normal range. More particularly, the output matching circuit for the power amplifier and the input matching circuit for the low noise amplifier are both tuned to a standard impedance of 50 Ohm. If the return loss (S11) of the antenna is minimized to the aforementioned −15 dB level, performance degradation of the power amplifier remains negligible. As the various electrical components of communications devices are densely packed, interference between the antenna and such nearby components is also a source of performance degradation. With current antenna designs, the return loss (S11) at the edges of the operating frequency band is typically around −5 dB, leading to a reduced performance of the front end module. This, in turn, reduces the total radiated power, the total integrated sensitivity of the transceiver, and the quality of the digital signal. The cumulative effects of such performance degradations include shorter communication link distances, increased data transfer times, and a host of other problems attendant thereto.

Accordingly, there is a need in the art for patch antennas and cross-polarized patch antennas that have excellent return loss, wide bandwidth, high gain, and high efficiency. There is a need in the art for patch antennas and arrays with broader radiation patterns.

### BRIEF SUMMARY

In accordance with one embodiment of the present disclosure, an antenna assembly connectible to a radio frequency (RF) front end integrated circuit is contemplated. The connection may be a feeding line with a primary conductor and a secondary conductor. The antenna assembly may include a feed port that is connectible to the feeding line, and the feed port may define a first electrically conductive element connectible to the primary conductor and a second electrically conductive element connectible to the secondary conductor. There may be a first set of inner patch elements that each has substantially identical first dimensions corresponding to a center resonant operating frequency. The inner patch elements may also define perpendicular slots of predetermined lengths. A first one of the first set of inner patch elements may be in a spaced, parallel relationship to a second one of the first set of inner patch elements. There may also be a second set of outer patch elements that each has substantially identical second dimensions. The first set of inner patch elements may be in a spaced, parallel and interposed relationship between the second set of outer patch elements. The first electrically conductive element of the feed port may be connected to the first one of the first set of inner patch elements. The second electrically conductive element of the feed port may be connected to the second one of the first set of inner patch elements. The antenna assembly may have a compact size, high gain, high efficiency, wide bandwidth and good return loss with a wide radiation pattern.

Another embodiment of the present disclosure contemplates an antenna assembly that is connectible to a RF front end integrated circuit over a first feeding line and a second feeding line each with a primary conductor and a secondary conductor. There may be a first feed port that is connectible to the first feeding line, as well as a second feed port that is connectible to the second feeding line. The antenna assembly may include a first set of inner patch elements each having substantially identical first dimensions and defining perpendicular slots of predetermined lengths. A first one of the first set of inner patch elements may be in a spaced, parallel relationship to a second one of the first set of inner patch elements. The antenna assembly may also include a second set of outer patch elements each having substantially identical second dimensions. The first set of inner patch elements may be in a spaced, parallel and interposed relationship between the second set of outer patch elements. The first feed port and the second feed port may be electrically connected to each of the first set of inner patch elements. The first feed port may be oriented orthogonally to the second feed port for cross polarizing the patch elements.

Yet another embodiment contemplates an antenna array that is connectible to an RF front end circuit over a feeding line with a primary conductor and a secondary conductor. The antenna array may include a base and an array feed port connectible to the feeding line. There may also be a plurality of stacked patch element sets mounted to the base in an equally spaced relationship. Each of the stacked patch element sets may include an upper patch element having first dimensions corresponding to a center resonant frequency. The stacked patch element sets may also include a lower patch element that has second dimensions different from the first dimensions. The lower patch element may define perpendicular slots of predetermined lengths, and may be in a spaced, axially aligned, parallel relationship to the upper patch element. The antenna array may further include a power splitter circuit with a primary port connected to the array feed port. The power splitter circuit may also have a plurality of secondary ports that are each connected to a one of the plurality of stacked patch element sets. The secondary ports may each include first conductive elements that correspond to the primary conductor, and may be connected to the respective lower patch element of the plurality of stacked patch element sets. Furthermore, the secondary ports may each include a second conductive element that correspond to the secondary conductor and may be connected to the base.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of one embodiment of a linear-polarized patch antenna assembly;

FIG. 2 is a front view of the patch antenna assembly shown in FIG. 1;

FIG. 3 is a left side view of the patch antenna assembly shown in FIG. 1 and FIG. 2;

FIG. 4 is a Smith chart showing a simulated performance of the patch antenna assembly in accordance with one embodiment of the present disclosure;

FIG. 5 is a graph showing the simulated return loss and the actual return loss of the patch antenna assembly;

FIG. 6 is a three-dimensional graph illustrating a simulated radiation pattern of the patch antenna assembly;

FIG. 7 is a perspective view of one embodiment of a cross-polarized patch antenna assembly;

FIG. 8 is a front view of the cross-polarized patch antenna assembly shown in FIG. 7;

FIG. 9 is a left side view of the cross-polarized patch antenna assembly shown in FIG. 7 and FIG. 8;

FIG. 10 is a block diagram illustrating the basic component of a multiple input, multiple output communications system with which the cross-polarized patch antenna assembly may be utilized;

FIG. 11 is a Smith chart showing a simulated performance of the cross-polarized patch antenna assembly without a matching circuit;

FIG. 12 is an diagram of exemplary matching circuits connected to the cross-polarized patch antenna assembly;

FIG. 13 is a graph showing the simulated return loss of a first feed port and a second feed port, and the isolation between the first feed port and the second feed port after matching circuits are connected to the feed ports of the cross-polarized patch antenna assembly;

FIG. 14 is a three-dimensional graph illustrating a simulated radiation pattern of the cross-polarized patch antenna assembly;

FIG. 15 is a perspective view of one embodiment of a patch antenna array;

FIG. 16 is a top plan view of the patch antenna array shown in FIG. 15;

FIG. 17 is a side view of the patch antenna array shown in FIG. 15 and FIG. 16;

FIG. 18 is a graph showing the simulated return loss of the patch antenna array;

FIG. 19 is a Smith chart showing a simulated performance of the patch antenna array; and

FIG. 20 is a three-dimensional graph illustrating a simulated radiation pattern of the patch antenna array.

Common reference numerals are used throughout the drawings and the detailed description to indicate the same elements.

### DETAILED DESCRIPTION

The present disclosure contemplates various embodiments of patch antennas, cross-polarized patch antennas and patch antenna arrays with high gain, wide bandwidth, high efficiency, good return loss, and a broad radiation pattern. The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second, primary and secondary, and the like are used solely to distinguish one from another entity without necessarily requiring or implying any actual such relationship or order between such entities.

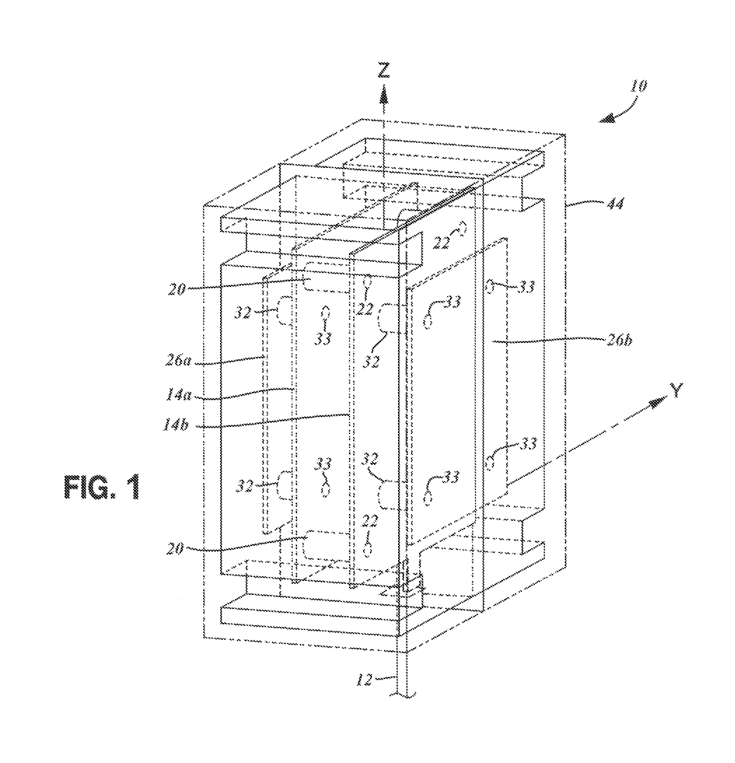

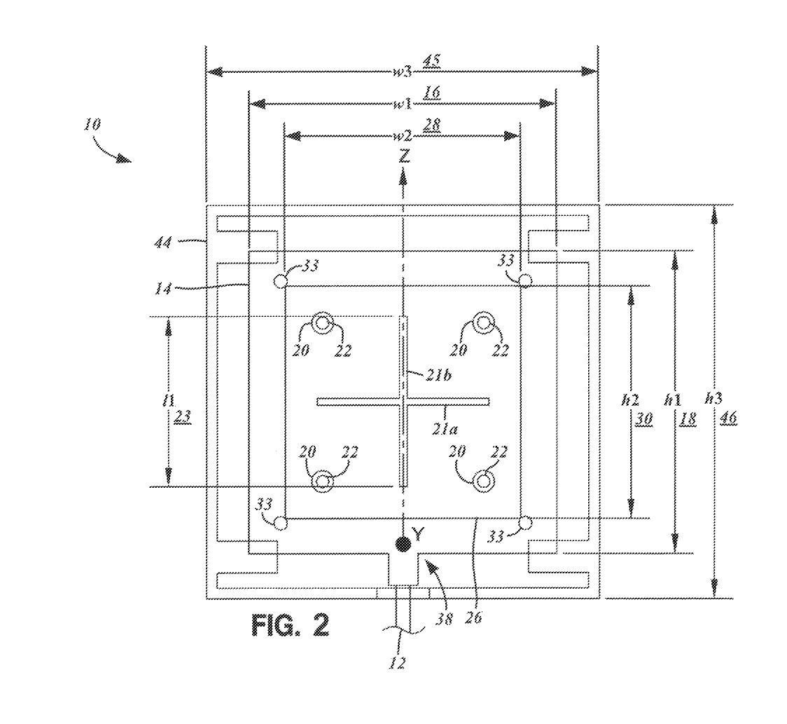

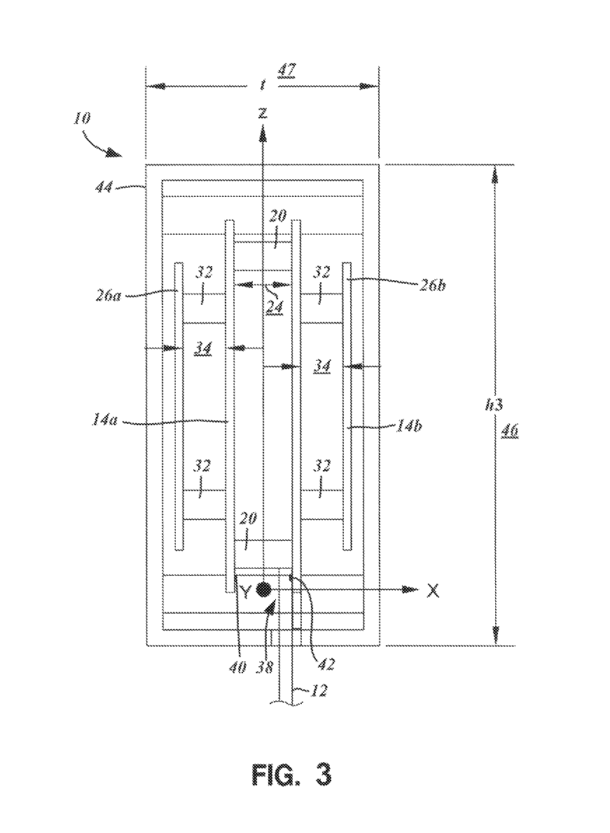

FIG. 1, FIG. 2 and FIG. 3 depict a first embodiment of a patch linear-polarized antenna assembly 10 that is connectible to a radio frequency (RF) front end integrated circuit. As described above, the front end circuit is connected to a radiator such as the patch antenna assembly 10 as well as a transceiver. RF signals generated by the transceiver are amplified by a power amplifier of the front end circuit and passed to the patch antenna assembly 10 for broadcast. RF signals are also received by the patch antenna assembly 10, amplified by a low noise amplifier of the front end circuit, and passed to the transceiver for further processing. The RF signals to and from the patch antenna assembly 10 are carried by a feeding line 12. Those having ordinary skill in the art will recognize the general operational principles of the transceiver and the front end circuit, and any suitable implementation may be utilized without departing from the scope of the present disclosure. Therefore, further details of the front end circuit will be omitted.

The patch antenna assembly 10 includes a first set of inner patch elements 14, including a first inner patch element 14a and a second inner patch element 14b that have substantially identical first dimensions. The inner patch elements 14 have a quadrangular configuration, and more particularly a square configuration with a width w1 16 of 50 mm and a height h1 18 also of 50 mm. In accordance with one embodiment, the thickness of the inner patch elements 14 is 0.8 mm. These dimensions are understood to correspond to a center resonant operating frequency, in this embodiment contemplated to be the 2.4 GHz Industrial-Scientific-Medical (ISM) band. The first inner patch element 14a is in a spaced, parallel relationship to the second inner patch element 14b. It is also contemplated that the first inner patch element 14a is axially centered with the second inner patch element 14b.

Although specific dimensions were disclosed above and will further be disclosed below in connection with the first embodiment of the patch antenna assembly 10 as well as other embodiments, it will be appreciated that these are by way of example only and not of limitation. Depending on the operating parameters, these dimensions may be modified. To the extent that specific dimensions relate to such operating parameters, any such interrelationships will be described.

For maintaining this spaced, parallel relationship between the inner patch elements 14, there is at least one support member 20 that has one end attached to the first inner patch element 14a and an opposed end attached to the second inner patch element 14b. Preferably, though optionally, there are four support members 20 for structural rigidity. In this embodiment, the spacing between the first inner patch element 14a and the second inner patch element 14b, that is, a first separation distance 24, is 8 mm. Many variations in configuration are possible, though one contemplated embodiment utilizes a hollow post as the support member 20, with the inner patch elements 14 defining spaced holes 22 through which a fastener is inserted from the opposite side and secured to the hollow post/support member 20. The support member 20 and any components thereof including the hollow post and the fastener are constructed of a non-electrically conductive material such as plastic.

The patch antenna assembly 10 also includes a second set of outer patch elements 26, including a first outer patch element 26a and a second outer patch element 26b that have substantially identical second dimensions. The outer patch elements 26 also have a square configuration, but with a width w2 28 of 38 mm and a height h2 of 38 mm, which is different from the first dimensions of the inner patch elements 14. The thickness of the outer patch elements 26 may be 0.8 mm. As shown in FIG. 1 and FIG. 3, the outer patch elements 26 sandwich the first and second inner patch elements 14a, 14b. In other words, the inner patch elements 14 is in a spaced, parallel and interposed relationship between the outer patch elements 26. The outer patch elements 26 are understood to improve the bandwidth of the patch antenna assembly 10.

The first outer patch element 26a is separated from the first inner patch element 14a, and the second outer patch element 26b is separated from the second inner patch element 14b. This is likewise achieved with at least one support member 32 that is attached to the first outer patch element 26a and the first inner patch element 14a, as well as another support member 32 that is attached to the second outer patch element 26b and the second outer patch element 14b. This second separation distance 34, in accordance with one embodiment of the present disclosure, is 6 mm, which is different from the first separation distance 24 between the inner patch elements 14 and the outer patch elements 26. Otherwise, the way in which the support members 32 are mounted to the respective patch elements 14, 26 are the same as discussed in relation to the support members 20 that are mounted to and separating the first set of inner patch elements 14. The outer patch elements 26 accordingly define holes 33 for securing the support member 32.

With specific reference to FIG. 2, the first inner patch element 14a and the second inner patch element 14b define slots 21, including a horizontal slot 21a and a vertical slot 21b. The horizontal slot 21a is oriented in a perpendicular orientation to the vertical slot 21b. Along these lines, the horizontal slot 21a extends in a parallel relationship to the respective horizontal edges of the inner patch elements 14, while the vertical slot 21b extends in a parallel relationship to the respective vertical edges of the inner patch elements 14. The slots 21 are understood to control the RF energy coupling between the inner patch elements 14 and the outer patch elements 26. The length of each of the slots 21 can be adjusted to optimize return loss and bandwidth of the patch antenna assembly 10 without the need for a matching circuit. According to one embodiment, the slots 21 have length l1 23 of 28 mm and a width of 1 mm. Because the slots 21 are defined by the inner patch elements 14, the thickness of the slots 21 is the same: 0.8 mm.

As briefly indicated above, the patch antenna assembly 10 is connected to a feeding line 12. In further detail, the patch antenna assembly 10 includes a feed port 38 that is connectible to the feeding line 12. It is understood that the feeding line 12, which in one embodiment is a coaxial cable with an impedance of 50 Ohm, includes a primary (inner) conductor and a secondary (outer) conductor. The primary conductor is connected to a first electrically conductive element 40 of the feed port 38, which is also connected to the first inner patch element 14a. The secondary conductor is connected to a second electrically conductive element 42 of the feed port 38, which is connected to the second inner patch element 14b. The connection point of the feeding line 12, that is, the first electrically conductive element 40 and the second electrically conductive element 42, are soldered on to the respective inner patch elements 14 approximately 6.5 mm from its edge.

Each of the patch elements 14, 26 are electrically conductive and have the aforementioned 0.8 mm thickness. In one embodiment, the patch elements 14, 26 may be solid metallic plates. Alternatively, the patch elements 14, 26 may be a metallic (e.g., copper) sheet laminated on to a substrate. In particular, it may be a 0.8 mm thickness, double-sided FR4 printed circuit board having a 30 mil substrate thickness, with ½ oz. copper. In this embodiment, several via holes electrically connect the first sheet side to the second sheet side.

The patch elements 14, 26 are enclosed in a radome 44 to protect the same, and to reduce the overall size of the patch antenna assembly 10. The radome 44 is sized such that there is an air gap defined between it and the outer patch elements 26, and according to one contemplated embodiment, the air gap is approximately 2 mm or larger. Based upon the forgoing configuration of the outer patch elements 26 and the inner patch elements 24, the radome 44 is understood to have a width w3 45 of 64 mm, a height h3 46 of 64 mm, and a thickness t 47 of 31.2 mm. The thickness of the wall of the radome 44 is also 2 mm, and may be constructed of polyvinyl chloride (PVC) plastic, which has a dielectric constant εᵣ of 2.6. Different materials for the radome 44 can be utilized, though different dimensions of the patch elements 14, 26 as well as the slots 21 may be necessary.

The above-described patch antenna assembly 10 is understood to employ multi-resonance superposition. The principles are explained in U.S. patent application Ser. No. 12/914,922 entitled “FIELD-CONFINED WIDEBAND ANTENNA FOR RADIO FREQUENCY FRONT END INTEGRATED CIRCUITS,” the disclosure of which is wholly incorporated by reference in its entirety herein. Although conventional patch antennas are known to exhibit high peak gain characteristics, bandwidth is typically narrow. The two pairs of stacked patch elements 14, 26 are understood have different dimensions to generate two separate resonances, thereby widening the bandwidth of the patch antenna assembly 10. For achieving omni-directional radiation patterns in both horizontal and vertical planes, the grounding plane element is understood to have the same dimensions as the radiating element. Accordingly, the back radiation is envisioned to have substantially similar power as the forward radiation, resulting in an approximately spherical radiation pattern.

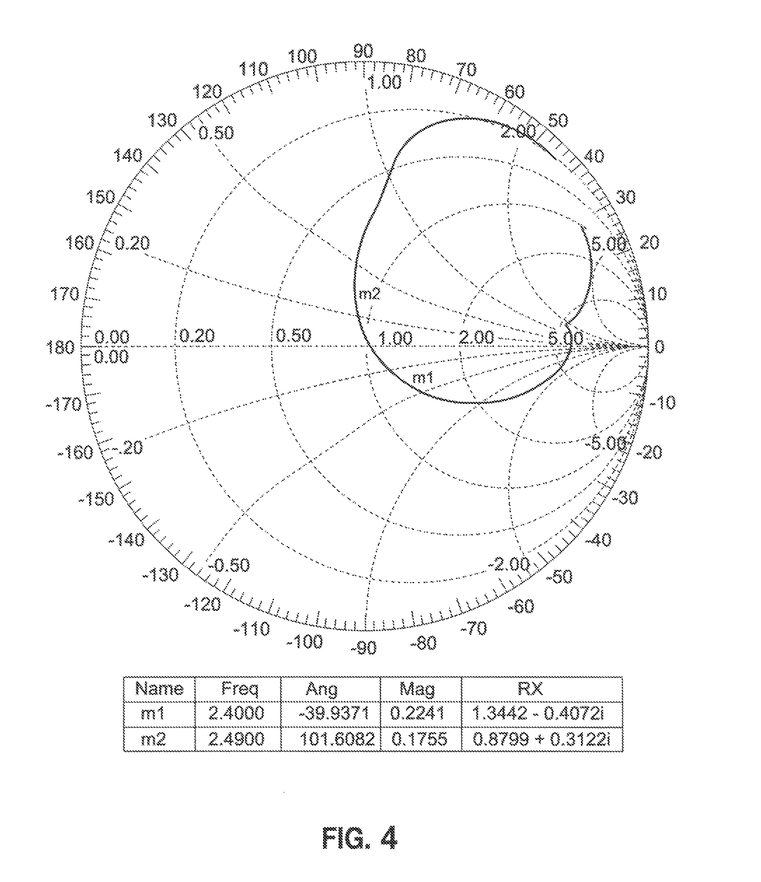

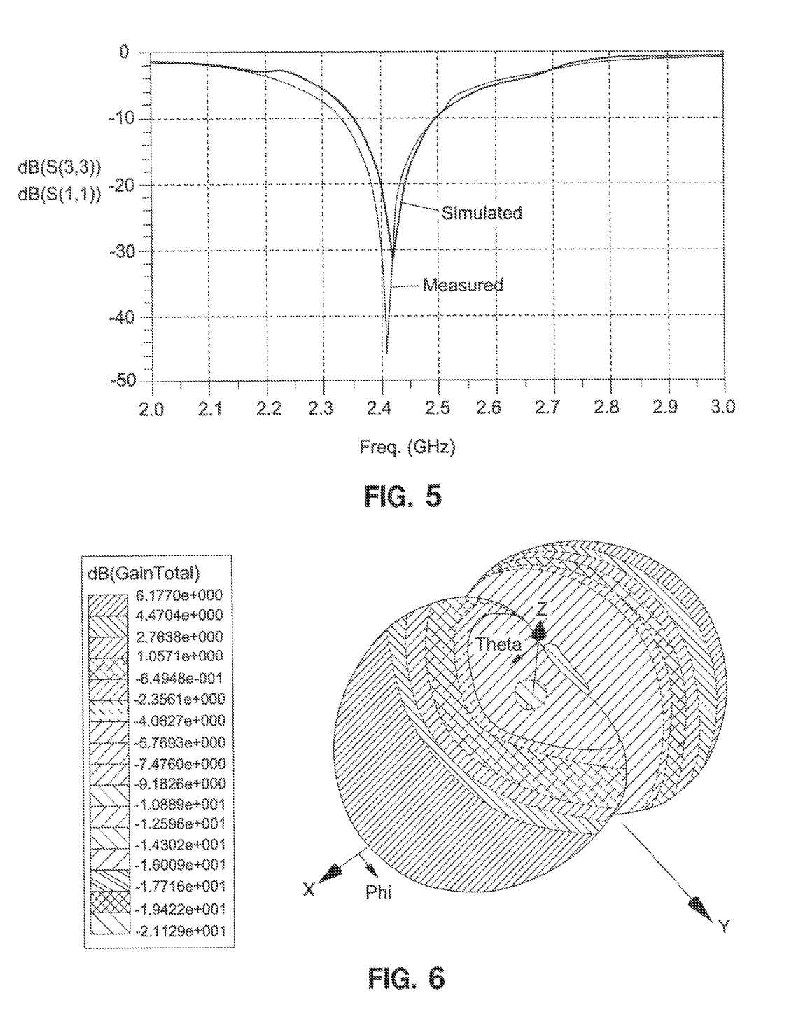

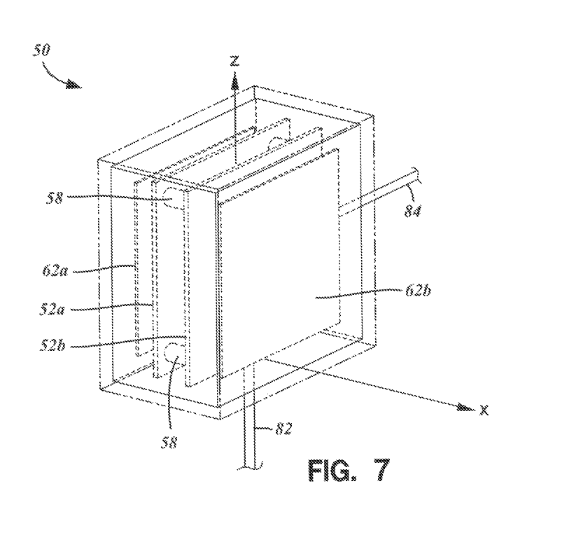

The above-described first embodiment of the patch antenna assembly 10 has been configured for the ISM 2.4 GHz operating frequency band, and its performance has been simulated. FIG. 4 is a Smith chart based upon the simulation results, and shows that the patch antenna assembly 10 has a bandwidth of approximately 300 MHz with a return loss (S11) of −10 dB. FIG. 5 is a comparison between the simulated and actual return loss across the operating frequency band of 2400 to 2483.5 MHz, and shows that it is better than −15 db in that range. Furthermore, FIG. 6 illustrates the omni-directional radiation pattern mentioned above, with the peak gain being approximately +6.2 dbi. More particularly, there is understood to be two maximum radiation directions along the normal direction of the surface of the patch elements 14, 26. Even in the radiation directions that are perpendicular to the maximum radiation directions, the patch antenna assembly 10 has a gain of approximately −5 dB. Thus in the horizontal plane (XY) as well as the vertical planes (XZ and YZ), the patch antenna assembly 10 has an approximately omni-directional radiation pattern. It is contemplated that these operational characteristics render the patch antenna assembly 10 suitable for various wireless communications applications including WLAN access points, WLAN and Zigbee network interface controllers for mobile devices, and so forth. Again, although a specific configuration of the patch antenna assembly 10 for the 2.4 GHz ISM operating frequency band has been described, those having ordinary skill in the art will recognize that the specific dimensions may be modified for other operating frequency bands.

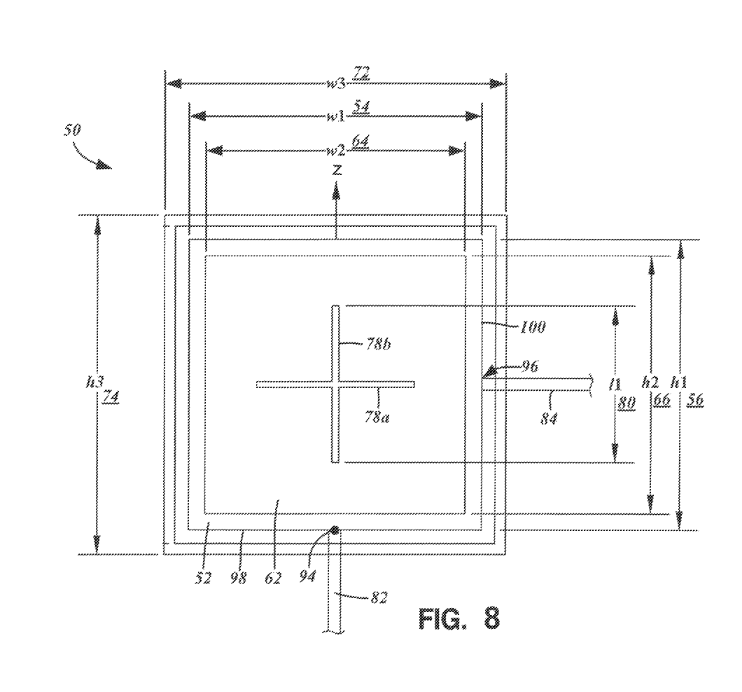

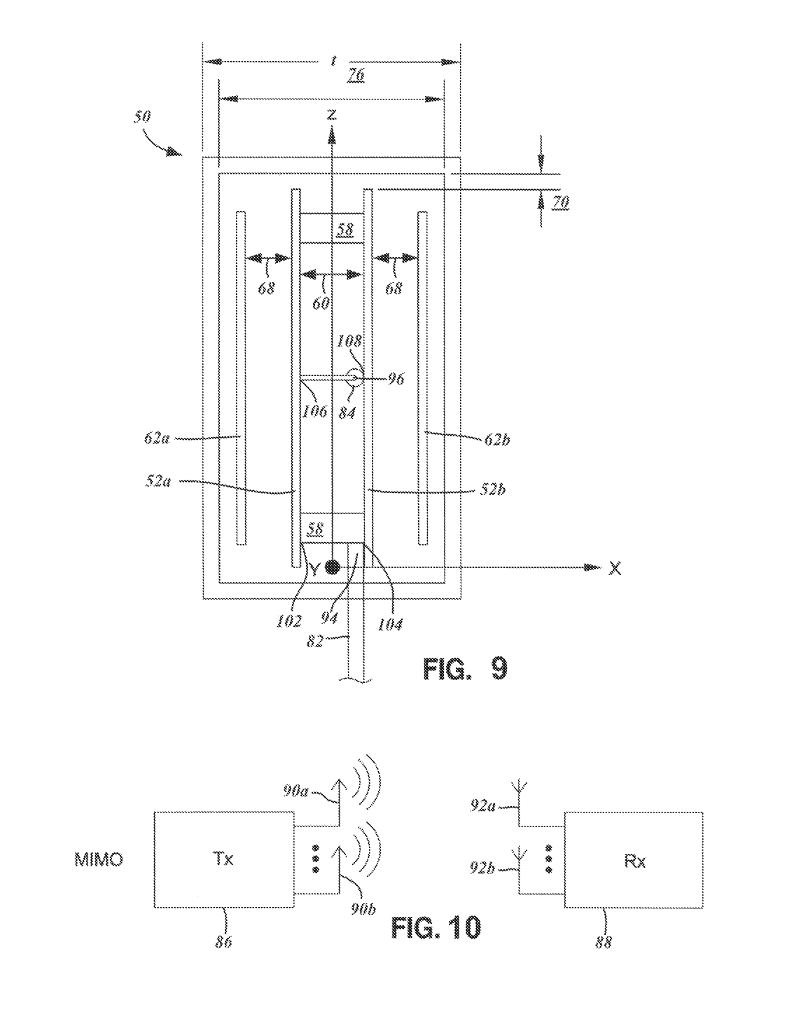

Referring now to FIG. 7, FIG. 8 and FIG. 9, one embodiment of a cross-polarized patch antenna assembly 50 will be described. The cross-polarized patch antenna assembly 50 includes a first set of inner patch elements 52, including a first inner patch element 52a and a second inner patch element 52b that have substantially identical first dimensions. The inner patch elements 52 have a quadrangular configuration, and more particularly a square configuration with a width w1 54 of 48 mm and a height h1 56 also of 48 mm. In accordance with one embodiment, the thickness of the inner patch elements 52 is 0.8 mm. These dimensions are understood to correspond to a center resonant operating frequency, in this embodiment contemplated to be the 2.4 GHz Industrial-Scientific-Medical (ISM) band. The first inner patch element 52a is in a spaced, parallel relationship to the second inner patch element 52b. It is also contemplated that the first inner patch element 52a is axially centered with the second inner patch element 52b.

For maintaining the spaced, parallel relationship between the inner patch elements 52, there is at least one support member 58 that has one end attached to the first inner patch element 52a and an opposed end attached to the second inner patch element 52b. There are four support members 58 for structural rigidity. In this embodiment, the spacing between the first inner patch element 52a and the second inner patch element 52b, that is, a first separation distance 60, is 8 mm.

The cross-polarized patch antenna assembly 50 includes a second set of outer patch elements 62, including a first outer patch element 62a and a second outer patch element 62b that have substantially identical second dimensions. The outer patch elements 62 also have a square configuration, but with a width w2 64 of 42 mm and a height h2 66 of 42 mm, which is different from the first dimensions of the inner patch elements 52. The thickness of the outer patch elements 62 may be 0.8 mm. The outer patch elements 62 sandwich the first and second inner patch elements 52a, 52b, that is, the inner patch elements 52 are in a spaced, parallel and interposed relationship between the outer patch elements 62. The outer patch elements 62 improve the bandwidth of the cross-polarized patch antenna assembly 50.

The first outer patch element 62a is separated from the first inner patch element 52a, and the second outer patch element 62b is separated from the second inner patch element 52b. This second separation distance 68 is 6 mm, which is different from the first separation distance 60 between the inner patch elements 52 and the outer patch elements 62.

Each of the patch elements 52, 62 are electrically conductive and have the aforementioned 0.8 mm thickness. In one embodiment, the patch elements 52, 62 may be solid metallic plates. In another embodiment, the patch elements 52, 62 may be a metallic (e.g., copper) sheet laminated on to a substrate. In particular, it may be a 0.8 mm thickness, double-sided FR4 printed circuit board having a 30 mil substrate thickness, with ½ oz. copper. Several via holes electrically connect the first sheet side to the second sheet side.

The patch elements 52, 62 are enclosed in a radome 68 for protection and for reducing the overall size of the cross-polarized patch antenna assembly 50. The radome 68 is sized such that there is an air gap defined between it and the outer patch elements 62, and according to one embodiment, the air gap is approximately 2 mm or larger. Based upon the forgoing configuration of the outer patch elements 62 and the inner patch elements 52, the radome 68 is understood to have a width w3 72 of 54 mm, a height h3 74 of 54 mm, with a thickness t 76 of 32 mm. The thickness of the wall of the radome 68 is 2 mm, and may be constructed of polyvinyl chloride (PVC) plastic, though different materials can be utilized. The interior space of the radome 68 is 52 mm by 52 mm by 30 mm.

Referring now to FIG. 8, the first inner patch element 52a and the second inner patch element 52b define slots 78, including a horizontal slot 78a and a vertical slot 78b. The horizontal slot 78a is oriented in a perpendicular orientation to the vertical slot 78b. The horizontal slot 78a extends in a parallel relationship to the respective horizontal edges of the inner patch elements 52, while the vertical slot 78b extends in a parallel relationship to the respective vertical edges of the inner patch elements 52. The slots 78 are understood to control the RF energy coupling between the inner patch elements 52 and the outer patch elements 62. The length of each of the slots 78 can be adjusted to optimize return loss and bandwidth of the cross-polarized patch antenna assembly 50 without the need for a matching circuit. According to one exemplary embodiment, the slots 78 have length l1 80 of 28 mm and a width of 1 mm. Because the slots 78 are defined by the inner patch elements 52, the thickness thereof is likewise 0.8 mm.

The cross-polarized patch antenna assembly 50 is connected to the front end circuit over a first feeding line 82 and a second feeding line 84. The block diagram of FIG. 10 best illustrates a multiple input, multiple output (MIMO) communications system including a first transceiver 86 in a transmit mode and a remote second transceiver 88 in a receive mode. The first transceiver 86 has multiple transmitting antennas 90a, 90b, and the second transceiver 88 has multiple receiving antennas 92a, 92b. The present disclosure contemplates utilizing the single, cross-polarized patch antenna assembly 50 to act as these two separate antennas 90a, 90b and 92a, 92b. Thus, the first feeding line 82 is understood to excite a first field mode, while the second feeding line 84 is understood to excite a second field mode that is orthogonal to the first field mode. This is achieved by connecting the first feeding line 82 to the cross-polarized patch antenna assembly 50 in a perpendicular relationship to the second feeding line 84. Accordingly, the cross-polarized patch antenna assembly 50 includes a first feed port 94 that is disposed along a horizontal edge 98 of the inner patch elements 52 and a second feed port 96 that is disposed along a vertical edge 100 of the inner patch elements 52.

Each of the feeding lines 82, 84 includes a primary (inner) conductor that is connected to the first inner patch element 52a and a secondary (outer) conductor that is connected to the second inner patch element 52b. It is contemplated that the feeding lines 82, 84 are implemented as RF coaxial cables, with the inner conductor corresponding to the aforementioned primary conductor, and the outer conductor corresponding to the aforementioned secondary conductor. By way of example only and not of limitation, the feeding lines 82, 84 are semi-rigid 085 type coaxial cables. The primary conductor of the first feeding line 82 is thus connected, via a first electrically conductive element 102, to the first inner patch element 52a, while the secondary conductor of the first feeding line 82 is connected to the second inner patch element 52b via a second electrically conductive element 104. Similarly, the primary conductor of the second feeding line 84 is connected, via a first electrically conductive element 106, to the first inner patch element 52a and the secondary conductor of the second feeding line 84 is connected to the second inner patch element 52b via a second electrically conductive element 108. The connection point of the first electrically conductive elements 102, 106 to the first inner patch element 52a, and the connection point of the second electrically conductive elements 104, 108 to the second inner patch element 52b, are understood to be approximately 5.5 mm from the respective horizontal edges 98 and vertical edges 100.

The cross-polarized patch antenna assembly 50 is understood to employ multi-resonance superposition. The two pairs of stacked patch elements 52, 62 are understood have different dimensions to generate two separate resonances, thereby widening the bandwidth. For achieving omni-directional radiation patterns in both horizontal and vertical planes, the grounding plane element is understood to have the same dimensions as the radiating element. Accordingly, the back radiation is envisioned to have substantially similar power as the forward radiation, resulting in an approximately spherical radiation pattern.

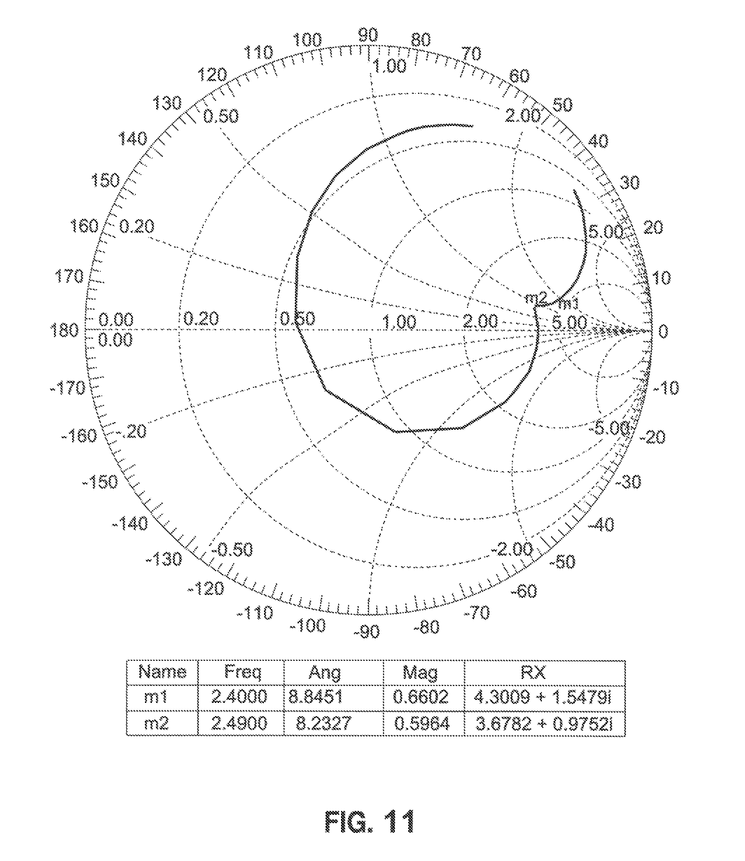

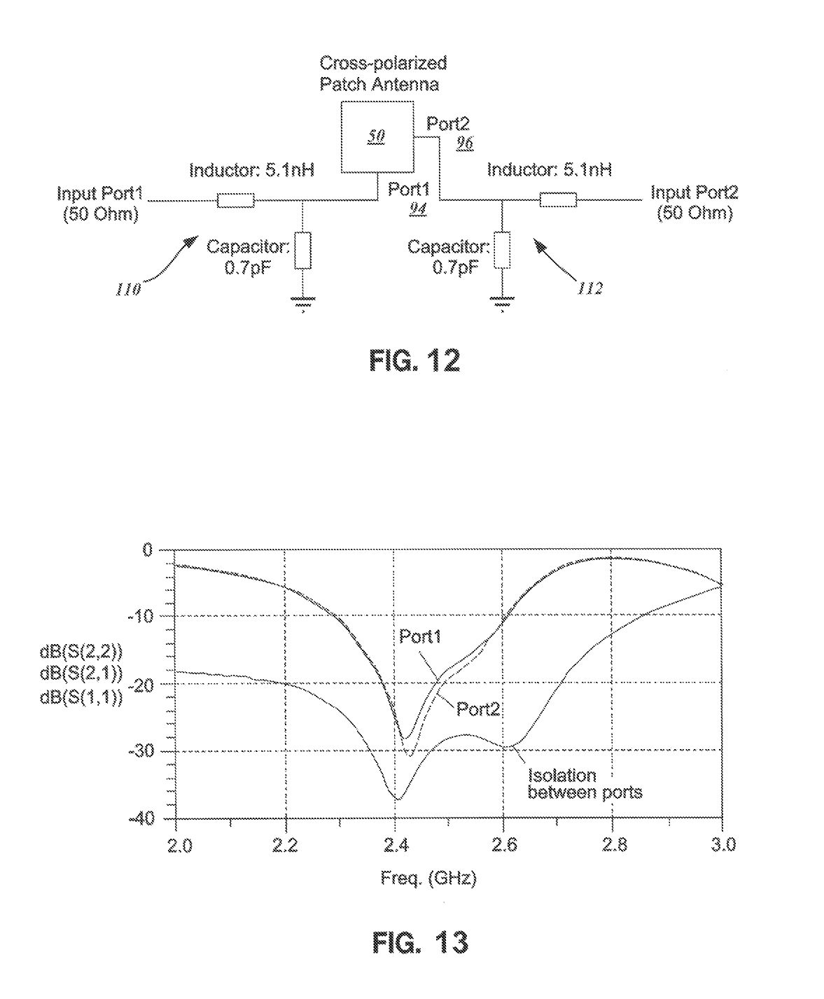

As with the linear-polarized patch antenna assembly 10 discussed above, the embodiment of the cross-polarized patch antenna assembly 50 has been configured for the ISM 2.4 GHz operating frequency band, and its performance has been simulated. FIG. 11 is a Smith chart based upon the simulation results without matching circuits. Furthermore, the Smith chart illustrates that the cross-polarized patch antenna assembly 50 can be readily matched to a 50 Ohm impedance of the front end circuit/feeding lines 82, 84. In this regard, the circuit diagram of FIG. 12 shows the first feed port 94 of the cross-polarized patch antenna assembly 50 connected to a simple first matching circuit 110 comprised of a 5.1 nH inductor and a 0.7 pF capacitor. The second feed port 96 is connected to an identical second matching circuit 112. The first and second matching circuits 110, 112 can be configured identically partly due to the square shape of the patch elements 52, 62 and a symmetrical structure of the feed ports 94, 96.

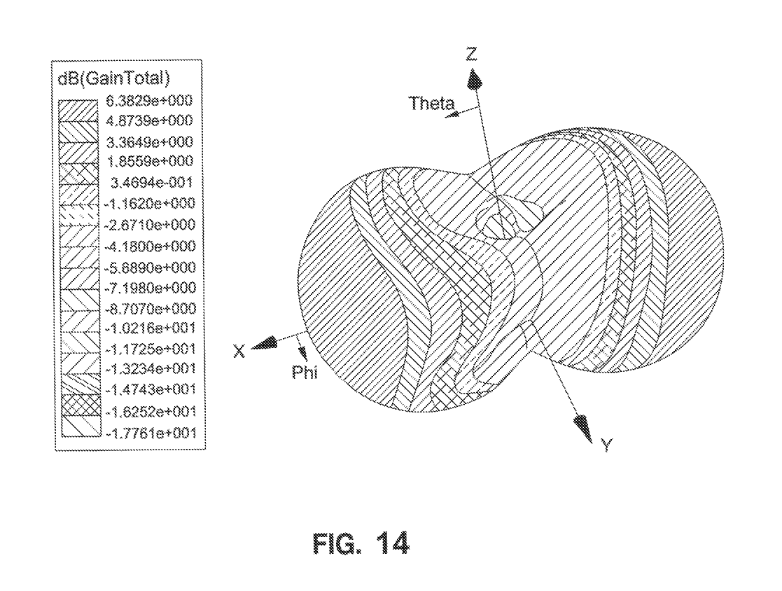

FIG. 13 illustrates the simulated return loss with the matching circuits connected to the cross-polarized patch antenna assembly 50, and shows that the bandwidth at S11=−10 dB is 300 Mhz. Across the operating frequency band of 2400 to 2483.5 MHz, and the return loss is better than −18 db in that range. Isolation between the first feed port 94 and the second feed port 96 is better than −28 dB in the operating frequency band. Additionally, FIG. 14 illustrates the omni-directional radiation pattern of the cross-polarized patch antenna assembly 50, with the peak gain being approximately +6.4 dbi. There are two maximum radiation directions along the normal direction of the surface of the patch elements 52, 62. Even in the radiation directions that are perpendicular to the maximum radiation directions, the cross-polarized patch antenna assembly 50 has a gain of approximately −5 dB. Thus in the horizontal plane (XY) as well as the vertical planes (XZ and YZ), the cross-polarized patch antenna assembly 50 has an approximately omni-directional radiation pattern Likewise, it is contemplated that these operational characteristics render the cross-polarized patch antenna assembly 50 suitable for various wireless communications applications including WLAN access points, WLAN and Zigbee network interface controllers for mobile devices, WLAN repeaters, 2×2 MIMO systems and so forth. Circular-polarized implementations are also possible with a 90-degrees phase shifter connected between the first feed port 94 and the second feed port 96. While a specific configuration of the cross-polarized patch antenna assembly 50 for the 2.4 GHz ISM operating frequency band has been described, those having ordinary skill in the art will recognize that the specific dimensions may be modified for other operating frequency bands.

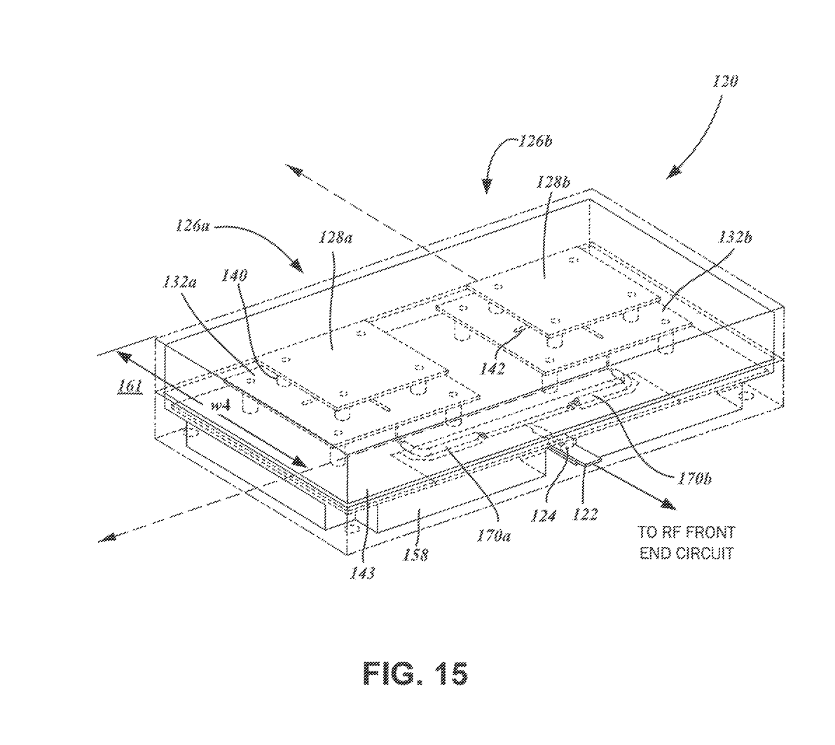

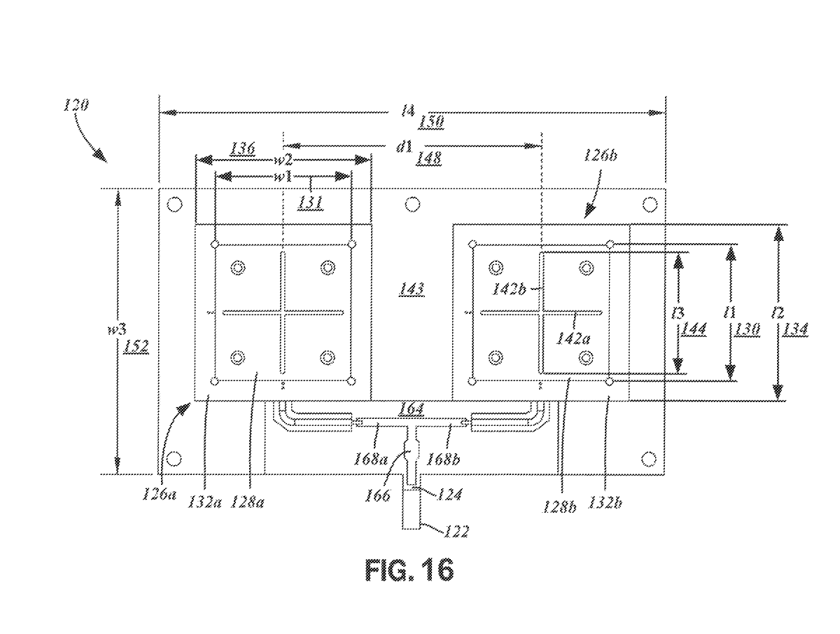

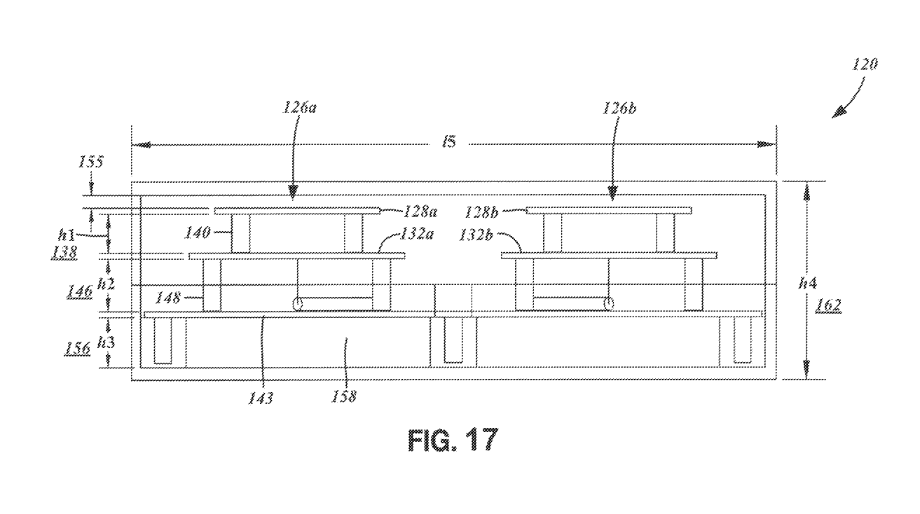

With reference to FIG. 15, FIG. 16, and FIG. 17, there is shown a patch antenna array 120 in accordance with another embodiment of the present disclosure. The patch antenna array 120 is connected to the RF front end circuit with a feeding line 122 via an array feed port 124. In further detail, the patch antenna array 120 includes a plurality of stacked patch element sets 126, including a first one 126a and a second one 126b. The first stacked patch element set 126a includes a first upper patch element 128a having a length l1 130 of 37 mm, and a width w1 131 also of 37 mm, i.e., a square configuration. These dimensions of the first upper patch element 128a are understood to correspond to a center resonant frequency of the patch antenna array 120. The second stacked patch element set 126b includes a second upper patch element 128b with the same dimensions. The first stacked patch element set 126a also includes a first lower patch element 132a having a length l2 134 of 48 mm and a width w2 136 of 48 mm, i.e. a square configuration. The second stacked patch element set 126b likewise includes a second lower patch element 132b with the same dimensions as the first lower patch element 132a. As the first stacked patch element set 126a is identical to the second stacked patch element set 126b in almost all respects, the components thereof, including the upper patch elements 128 and the lower patch elements 132 will be referenced collectively thus unless otherwise necessary to refer specifically to the first upper patch element 128a, the second upper patch element 128b, the first lower patch element 132a, or the second lower patch element 132b.

Each of the patch elements 128, 132 are electrically conductive and have a thickness of 0.8 mm. One embodiment contemplates the patch elements 128, 132 being solid metallic plates. Alternatively, the patch elements 128, 132 may be a metallic (e.g., copper) sheet laminated on to a substrate. In particular, it may be a 0.8 mm thickness, double-sided FR4 printed circuit board having a 30 mil substrate thickness, with ½ oz. copper. In this embodiment, several via holes electrically connect the first sheet side to the second sheet side.

In both the first stacked patch element set 126a and the second stacked patch element set 126b, the respective upper patch elements 128a, 128b are in a spaced, axially aligned, parallel relationship to the corresponding lower patch elements 132a, 132b. The separation height h1 138 between the upper patch elements 128 and the lower patch elements 132 is understood to be 6 mm. In this regard, there is at least one support element 140 that is mounted to both the upper patch elements 128 and the lower patch elements 132 and having a length of 6 mm. The outer diameter of the support element 140 is understood to be 2 mm. So that there is minimal influence on the patch antenna array 120, the support element 140 is constructed of Teflon-coated plastic.

As best illustrated in FIG. 16, the lower patch elements 132 each define slots 142, including a horizontal slot 142a and a vertical slot 142b. The horizontal slot 142a is oriented in a perpendicular orientation to the vertical slot 142b. The horizontal slot 142a extends in a parallel relationship to the respective horizontal edges of the lower patch elements 132, while the vertical slot 142b extends in a parallel relationship to the respective vertical edges of the lower patch elements 132. The slots 142 are understood to control the RF energy coupling between the lower patch elements 132 and the upper patch elements 128. The length of each of the slots 142 can be adjusted to optimize return loss and bandwidth. The slots 78 have length l3 144 of 34 mm, a width of 1 mm, and a thickness of 0.8 mm.

The stacked patch element sets 126 are mounted to a rectangular base 143 in a spaced relationship to each other. Specifically, the lower patch elements 132 are placed above the base 143 with a separation height h2 146 of 8 mm. Thus, there is at least another support element 148 that is mounted to the lower patch elements 132 and the base 143. Except for the dimensions, the support elements 148 are the same as the support elements 140 discussed above. The spacing between the first stacked patch element set 126a and the second stacked patch element set 126b is defined by a separation distance d1 148 of 70 mm. The separation distance d1 148 defines the coupling between the first stacked patch element set 126a and the second stacked patch element set 126b, in addition to the half-power beamwidth (HPBW) in the XY plane, where theta is 90 degrees. As with the patch elements 128, 132, the base 143 may be a double-sided FR4 printed circuit board having a 30 mil substrate thickness and ½ oz. copper, with an overall thickness of 8 mm. In one contemplated embodiment, the base has a length l4 150 of 138 mm and a width w3 152 of 78 mm.

The stacked patch element sets 126 and the base 143 are enclosed in a radome 154 for protective purposes and for reducing the overall size of the patch antenna array 120. The radome 154 is sized such that there is an air gap 155 defined between it and the upper patch elements 128, which is approximately 2 mm or larger. Additionally, the base 143 is positioned above the radome 154 by a height h3 156 of 7.6 mm with another support platform 158. The radome has a thickness of 2 mm, a length l5 160 of 144 mm, a width w4 161 of 84 mm, and a height h4 162 of 30 mm. The radome 154 may be constructed of polyvinyl chloride (PVC) plastic, though different materials can be utilized.

The patch antenna array 120 also includes a power splitter circuit 164 that has a primary port 166 connected to the array feed port 124. There is a first secondary port 168a connected to the first stacked patch element set 126a. A second secondary port 168b is connected to the second stacked patch element set 126b. It is contemplated that the feeding line 122 is comprised of a primary conductor and a secondary conductor. The primary conductor, via the secondary ports 168, is connected to the respective lower patch elements 132. The secondary conductor is connected to the base 143. The link between the secondary ports 168 and the lower patch elements 132 may be a 50 Ohm coaxial cable 170, or a 50 Ohm microstrip line. The connection point on the lower patch elements 132 is understood to be approximately 4.5 mm from its edge, though this may be adjusted for tuning the return loss of the patch antenna array 120.

The foregoing patch antenna array 120 is understood to employ multi-resonance superposition as mentioned above. The two elements of the stacked patch element sets 126 are understood have different dimensions to generate two separate resonances, thereby widening the bandwidth of the patch antenna array 120.

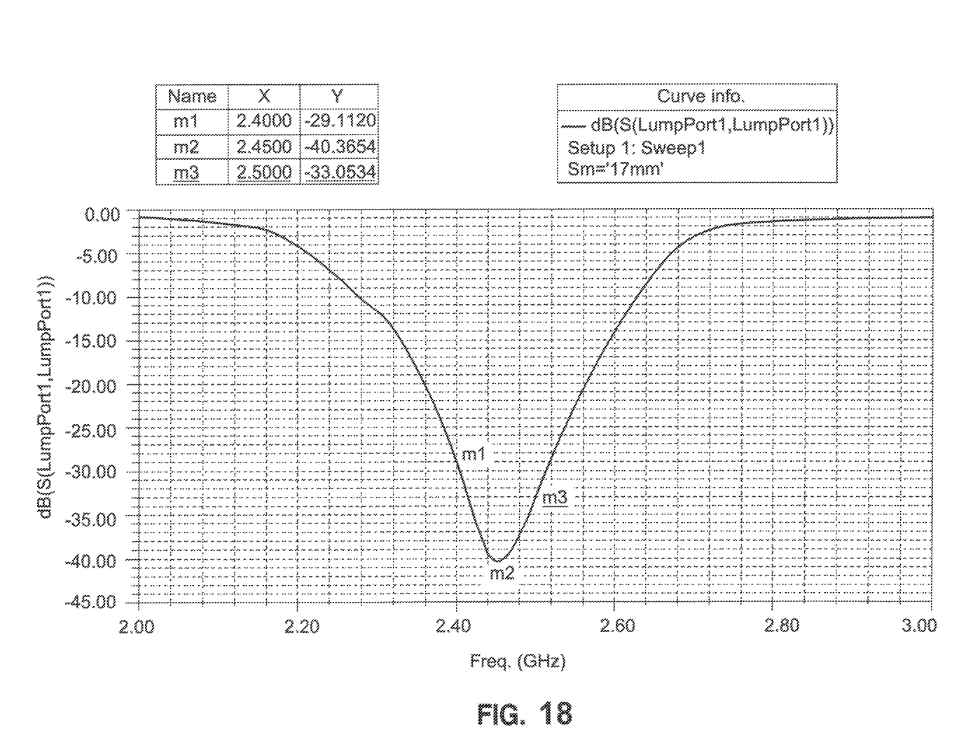

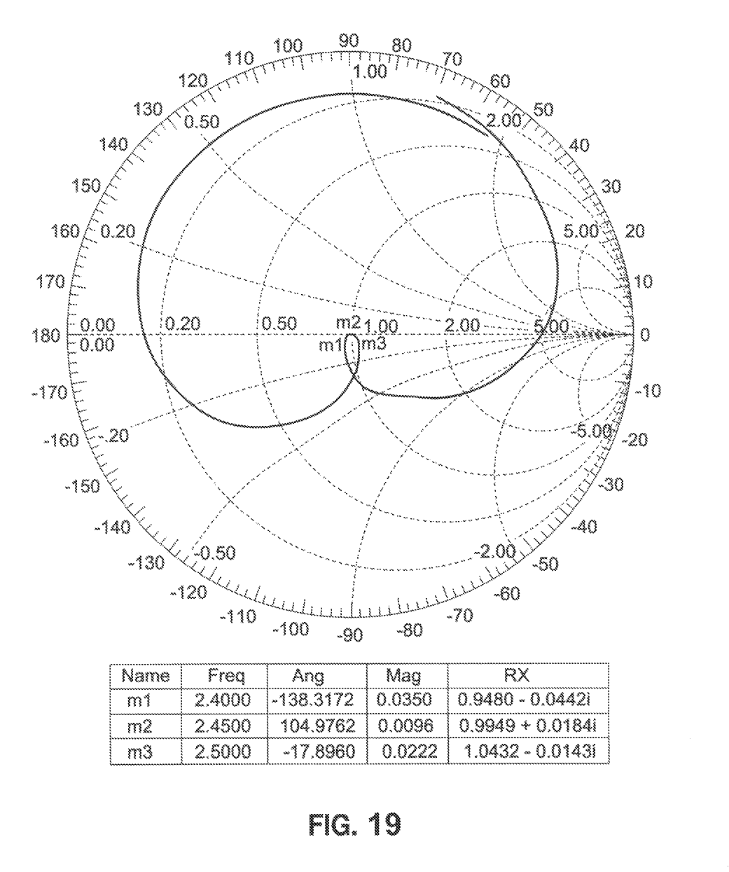

The above-described first embodiment of the patch antenna array 120 has been configured for the ISM 2.4 GHz operating frequency band, and its performance has been simulated. FIG. 18 depicts the simulated return loss, which is better than −29 dB across the operating frequency band of 2400 to 2483.5 MHz. The bandwidth is extra wide, i.e., 350 MHz with a return loss (S11) of −10 dB. FIG. 19 is a Smith chart based upon the simulation results, and shows that the input impedance of the patch antenna array 120 is match to 50 Ohm, so no additional matching circuit is necessary. These operational characteristics render the patch antenna array 120 suitable for various wireless communications applications including WLAN access points, WLAN and Zigbee network interface controllers for mobile devices, and so forth.

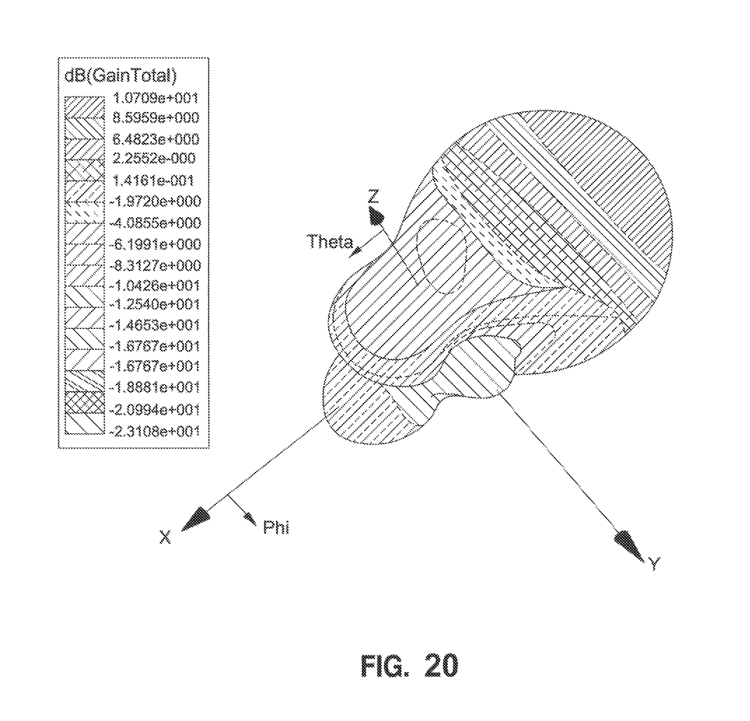

FIG. 20 illustrates an omni-directional radiation pattern, with the peak gain being approximately +10.7 dbi that includes the insertion loss of −0.5 dB associated with the power splitter circuit 164. The simulated peak directivity is +13.19 dBi at 2.45 GHz, and the simulated radiation efficiency is 89.33% at 2.45 GHz. The maximum radiation direction is along the x-axis. In the YZ plane (phi=90 degrees), the radiation pattern is omni-directional, while in the XZ plane (phi=0 degrees), the simulated half-power beamwidth is 60 degrees. In the XY plane (theta=90 degrees) the simulated half-power beamwdith is 45 degrees. Although there is understood to be some back radiation, this can be reduced by enlarging the dimensions of the base 143. One additional effect of enlarging the dimensions of the base 143 is increased peak gain.

A specific configuration of the patch antenna array 120 for the 2.4 GHz ISM operating frequency band has been described, but those having ordinary skill in the art will recognize that the specific dimensions may be modified for other operating frequency bands.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention with more particularity than is necessary for the fundamental understanding of the present invention, the description taken with the drawings making apparent to those skilled in the art how the several forms of the present invention may be embodied in practice.

What is claimed is:

1. An antenna assembly connectible to a radio frequency (RF) front end integrated circuit over a feeding line with a primary conductor and a secondary conductor, comprising:
a feed port connectible to the feeding line, the feed port defining a first electrically conductive element connectible to the primary conductor and a second electrically conductive element connectible to the secondary conductor;
a first set of inner patch elements each having substantially identical first dimensions corresponding to a center resonant operating frequency and defining perpendicular slots of predetermined lengths, a first one of the first set of inner patch elements being in a spaced, parallel relationship to a second one of the first set of inner patch elements; and
a second set of outer patch elements each having substantially identical second dimensions, the first set of inner patch elements being in a spaced, parallel and interposed relationship between the second set of outer patch elements;
wherein the first electrically conductive element of the feed port is connected to the first one of the first set of inner patch elements and the second electrically conductive element of the feed port is connected to the second one of the first set of inner patch elements.

2. The antenna assembly of claim 1, wherein the inner patch elements and the outer patch elements have a square configuration.

3. The antenna assembly of claim 1, wherein the first dimensions of the inner patch elements is different from the second dimensions of the outer patch elements.

4. The antenna assembly of claim 1, wherein a first separation distance between the first one of the first set of inner patch elements and the second one of the first set of inner patch elements is different from a second separation distance between the first one of the first set of inner patch elements and the first one of the second set of outer patch elements.

5. The antenna assembly of claim 1, wherein the patch elements are electrically conductive metallic plates.

6. The antenna assembly of claim 1, wherein the patch elements are defined by conductive laminate sheets.

7. The antenna assembly of claim 1, further comprising:
at least one support member attached to each of and separating the first one of the first set of inner patch elements and the second one of the first set of inner patch elements;
at least one support member attached to each of and separating the first one of the first set of inner patch elements and the first one of the second set of outer patch elements; and
at least one support member attached to each of and separating the second one of the first set of inner patch elements and the second one of the second set of outer patch elements.

8. The antenna assembly of claim 1, further comprising:
a radome enclosing the first set of inner patch elements and the second set of outer patch elements.

9. The antenna assembly of claim 8, wherein the radome is constructed of polyvinyl chloride (PVC) plastic.

10. The antenna assembly of claim 8, wherein an air gap is defined between an interior of the radome and the outer patch elements.

11. The antenna assembly of claim 10, wherein the air gap is at least 2 mm.

12. The antenna assembly of claim 1, wherein the predetermined lengths of the perpendicular slots corresponds to return loss and bandwidth of the antenna assembly.

13. An antenna assembly connectible to a radio frequency (RF) front end integrated circuit over a first feeding line and a second feeding line each with a primary conductor and a secondary conductor, comprising:
a first feed port connectible to the first feeding line;
a second feed port connectible to the second feeding line;
a first set of inner patch elements each having substantially identical first dimensions and defining perpendicular slots of predetermined lengths, a first one of the first set of inner patch elements being in a spaced, parallel relationship to a second one of the first set of inner patch elements; and
a second set of outer patch elements each having substantially identical second dimensions, the first set of inner patch elements being in a spaced, parallel and interposed relationship between the second set of outer patch elements;
wherein the first feed port and the second feed port are electrically connected to each of the first set of inner patch elements, the first feed port being oriented orthogonally to the second feed port for cross polarizing the patch elements.

14. The antenna assembly of claim 13, wherein the inner patch elements and the outer patch elements have a square configuration.

15. The antenna assembly of claim 13, wherein the first dimensions of the inner patch elements is different from the second dimensions of the outer patch elements.

16. The antenna assembly of claim 13, wherein a first separation distance between the first one of the first set of inner patch elements and the second one of the first set of inner patch elements is different from a second separation distance between the first one of the first set of inner patch elements and the first one of the second set of outer patch elements.

17. The antenna assembly of claim 13, wherein the patch elements are electrically conductive metallic plates.

18. The antenna assembly of claim 13, wherein the patch elements are defined by conductive laminate sheets.

19. The antenna assembly of claim 13, wherein:
the first feed port defines a first electrically conductive element connectible to the primary conductor of the first feeding line and a second electrically conductive element connectible to the secondary conductor of the first feeding line; and
the second feed port defines a first electrically conductive element connectible to the primary conductor of the second feeding line and a second electrically conductive element connectible to the secondary conductor of the second feeding line;

20. The antenna assembly of claim 19, wherein:
the first electrically conductive element of the first feed port is connected to the first one of the first set of inner patch elements; and
the second electrically conductive element of the first feed port is connected to the second one of the first set of inner patch elements.

21. The antenna assembly of claim 19, wherein:
the first electrically conductive element of the second feed port is connected to the first one of the first set of inner patch elements; and
the second electrically conductive element of the second feed port is connected to the second one of the first set of inner patch elements.

22. The antenna assembly of claim 13, further comprising:
a first matching circuit connected to the first feed port; and
a second matching circuit connected to the second feed port.

23. The antenna assembly of claim 22, wherein the impedance of the first matching circuit and the second matching circuit is 50 Ohms, matched to the RF front end integrated circuit.

24. The antenna assembly of claim 13, further comprising:
at least one support member attached to each of and separating the first one of the first set of inner patch elements and the second one of the first set of inner patch elements.

25. The antenna assembly of claim 13, further comprising:
a radome enclosing the first set of inner patch elements and the second set of outer patch elements.

26. The antenna assembly of claim 25, wherein the radome is constructed of polyvinyl chloride (PVC) plastic.

27. The antenna assembly of claim 25, wherein an air gap is defined between an interior of the radome and the outer patch elements.

28. The antenna assembly of claim 27, wherein the air gap is at least 2 mm.

29. The antenna assembly of claim 13, wherein the predetermined lengths of the perpendicular slots corresponds to return loss and bandwidth of the antenna assembly.

30. An antenna array connectible to a radio frequency (RF) front end module over a feeding line with a primary conductor and a secondary conductor, comprising:
a base;
an array feed port connectible to the feeding line;
a plurality of stacked patch element sets mounted on the base in an equally spaced relationship, each stacked patch element set including:
an upper patch element having first dimensions corresponding to a center resonant frequency;
a lower patch element having second dimensions different from the first dimensions and defining perpendicular slots of predetermined lengths, the lower patch element being in a spaced, axially aligned, parallel relationship to the upper patch element;
a power splitter circuit with a primary port connected to the array feed port and a plurality of secondary ports each connected to a one of the plurality of stacked patch element sets, the secondary ports each including first conductive elements corresponding to the primary conductor and connected to the respective lower patch element of the plurality of stacked patch element sets, and a second conductive element corresponding to the secondary conductor and connected to the base.

31. The antenna array of claim 30, wherein the upper patch element and the lower patch element have a square configuration.

32. The antenna array of claim 30, further comprising:
a radome enclosing the plurality of stacked patch element sets and the base.

33. The antenna array of claim 32, wherein the radome is constructed of polyvinyl chloride (PVC) plastic.

34. The antenna array of claim 32, wherein an air gap is defined between an interior of the radome and the upper patch elements.

35. The antenna array of claim 34, wherein the air gap is at least 2 mm.

36. The antenna array of claim 30, wherein the array feed port is centrally disposed on the base.

37. The antenna array of claim 30, wherein the patch elements are electrically conductive metallic plates.

38. The antenna array of claim 30, wherein the patch elements are defined by conductive laminate sheets.

39. The antenna array of claim 30, further comprising:
at least one support member attached to each of and separating the upper patch element and the lower patch element.

40. The antenna array of claim 30, wherein the predetermined lengths of the perpendicular slots corresponds to return loss and bandwidth of the antenna array.
